(19) United States
(12) Patent Application Publication
(10) Pub. No.: US 2025/0349273 A1
(43) Pub. Date: Nov. 13, 2025

(54) Acoustic Enhancing Double Guitar Pick

(71) Applicant: Michael Larsson, Blue Springs, MO (US)

(72) Inventor: Michael Larsson, Blue Springs, MO (US)

(21) Appl. No.: 18/753,004

(22) Filed: Jun. 25, 2024

Related U.S. Application Data
(60) Provisional application No. 63/643,449, filed on May 7, 2024.

(51) Int. Cl. G10D 3/173

(52) U.S. Cl. CPC G10D 3/173

(57) ABSTRACT

An acoustic enhancing guitar pick designed to improve the sound produced by a guitar is disclosed. The guitar pick comprises a broad arcuate side at the top end, a pair of style tips at the bottom end, and first and second side edges extending from the arcuate side to the style tips. The horizontally aligned style tips increase contact with the guitar strings, thereby enhancing vibrations and producing a brighter tone. The pick can be made from various materials, including plastic, bone, metal, wood, or composite materials, and can be customized in design and color. The method of using the pick involves positioning it so that the style tips simultaneously touch at least one guitar string, thereby enhancing sound without requiring new techniques from the guitarist.

### CROSS-REFERENCE TO RELATED APPLICATION

The present application claims priority to, and the benefit of, U.S. Provisional Application No. 63/643,449, which was filed on May 7, 2024, and is incorporated herein by reference in its entirety.

### FIELD OF THE INVENTION

The present invention generally relates to the field of guitar picks. More specifically, the present invention relates to a novel acoustic enhancing guitar pick designed to improve the sound produced by a guitar. The guitar pick includes a pair of style tips. The style tips are horizontally aligned to increase contact with the guitar strings, thereby enhancing vibrations and producing a brighter tone. Accordingly, the present disclosure makes specific reference thereto. Nonetheless, it is to be appreciated that aspects of the present invention are also equally applicable to other like applications, devices, and methods of manufacture.

### BACKGROUND

By way of background, musicians (both amateur and professional) use different types of musical equipment such as string devices (i.e., guitars) to create and enhance music. Many musicians try to achieve better sounds from their instruments and experiment with different tools and techniques such as deploying electrical components. However, use of such tools involves significant expenses and may require professional assistance. High-quality amplifiers, effect pedals, and other sound-enhancing devices can be costly, making them inaccessible to some musicians. The complexity of setting up and optimizing conventional tools can lead to frustration, especially for those who do not have the technical expertise or resources to take professional help. The lack of accessible and cost-effective sound enhancing tools for musicians such as guitarists deters them from creating better and unique sounds.

There have been no enhancements or improvements in music equipment such as guitar picks. Complex electronic systems have been developed to enhance sound from guitars but they are not accessible to all musicians and are difficult to use. Individuals desire a simple to use device such as an improved guitar pick to enhance the sound of a guitar.

Therefore, there exists a long-felt need in the art for an improved guitar pick. There is also a long-felt need in the art for an improved guitar pick for enhancing the sound produced by a guitar. Additionally, there is a long-felt need in the art for a special guitar pick that functions like a traditional guitar pick but improves the amplification of sound emitted from the guitar strings. Moreover, there is a long-felt need in the art for a uniquely designed guitar pick that has two style tips for producing a brighter tone and sharper attack. Further, there is a long-felt need in the art for a double guitar pick that enables musicians to achieve superior sound quality without the need for costly equipment or professional assistance. Furthermore, there is a long-felt need in the art for a guitar pick that makes high-quality sound enhancement more accessible to all guitarists. Finally, there is a long-felt need in the art for a uniquely designed double guitar pick that offers a simple and convenient method for adjusting the sound of a guitar.

The subject matter disclosed and claimed herein, in one embodiment thereof, comprises an acoustic enhancing guitar pick. The guitar pick is used like a conventional guitar pick and features a broad arcuate side at a top end, a pair of style tips at a bottom end, wherein the style tips align horizontally (i.e., colinear) to simultaneously contact with the strings of a guitar, a first side edge extends between a first end of the broad arcuate side and a first style tip, and a second side edge extends between a second end of the broad arcuate side and a second style tip. An inverted V-shape between the style tips functions as a resonance chamber to amplify sound and provide a sharper attack.

In this manner, the acoustic enhancing guitar pick of the present invention accomplishes all of the foregoing objectives and provides users with a novel double guitar pick that creates better sounds while playing the guitar. The double guitar pick functions like a traditional guitar pick but improves the amplification of sound emitted from the guitar strings, producing a brighter tone and sharper attack. The two style tips align horizontally (i.e., colinear) to simultaneously contact with the strings of a guitar to provide better vibrations and amplified sound. The double guitar pick can be used by all guitarists without any professional help.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an acoustic enhancing guitar pick. The guitar pick comprising a broad arcuate side at a top end, a pair of style tips at a bottom end, wherein the style tips align horizontally (i.e., colinear) to increase contact with the strings of a guitar, a first side edge extends between a first end of the broad arcuate side and a first style tip, and a second side edge extends between a second end of the broad arcuate side and a second style tip. An inverted V-shape between the style tips functions as a resonance chamber to amplify sound and provide a sharper attack.

In yet another embodiment, a double guitar pick is disclosed. The double guitar pick includes a first pick made from a first material, a second pick made from a second material different from the first material, a first style tip on the first pick, a second style tip on the second pick, wherein the first style tip and the second style tip align horizontally (i.e., colinear) to increase contact with the strings of a guitar, and wherein the double guitar pick enhances sound amplification by increasing vibrations and creating a brighter tone.

In another embodiment, a method for enhancing sound produced by a guitar is described. The method includes the steps of providing a double guitar pick having a broad arcuate side at a top end and a pair of style tips at a bottom end, aligning the style tips horizontally to increase contact with the strings of the guitar, positioning the double guitar pick such that the style tips simultaneously touch at least one string of the guitar, and amplifying the sound to produce a brighter tone and a sharper attack.

In another aspect, the broad arcuate side, the side edges, and the style tips form an interconnected teardrop shape.

In yet another aspect, the guitar pick is made from plastic, bone, and/or metal.

In still another embodiment, the double guitar pick is made of two materials, the first material is selected from the group consisting of wood, bone, and plastic, and the second material is selected from the group consisting of metal and composite material.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the double guitar pick of the present invention in accordance with the disclosed structure;

FIG. 2 illustrates a perspective view showing another embodiment of the double guitar pick of the present invention in accordance with the disclosed structure; and

FIG. 3 illustrates a perspective view showing use of the double guitar pick of the present invention for playing a guitar in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved guitar pick. There is also a long-felt need in the art for an improved guitar pick for enhancing the sound produced by a guitar. Additionally, there is a long-felt need in the art for a special guitar pick that functions like a traditional guitar pick but improves the amplification of sound emitted from the guitar strings. Moreover, there is a long-felt need in the art for a uniquely designed guitar pick that has two style tips for producing a brighter tone and sharper attack. Further, there is a long-felt need in the art for a double guitar pick that enables musicians to achieve superior sound quality without the need for costly equipment or professional assistance. Furthermore, there is a long-felt need in the art for a guitar pick that makes high-quality sound enhancement more accessible to all guitarists. Finally, there is a long-felt need in the art for a uniquely designed double guitar pick that offers a simple and convenient method for adjusting the sound of a guitar.

The present invention, in one exemplary embodiment, is a double guitar pick. The double guitar pick includes a first pick made from a first material, a second pick made from a second material different from the first material, a first style tip on the first pick, a second style tip on the second pick, wherein the first style tip and the second style tip align horizontally (i.e., colinear) to increase contact with the strings of a guitar, and wherein the double guitar pick enhances sound amplification by increasing vibrations and creating a brighter tone.

Reference will now be made in detail to the present preferred embodiments of the invention, examples of which are illustrated in the accompanying drawings. Wherever possible, the same reference numerals are used in the drawings and the description to refer to the same or like parts.

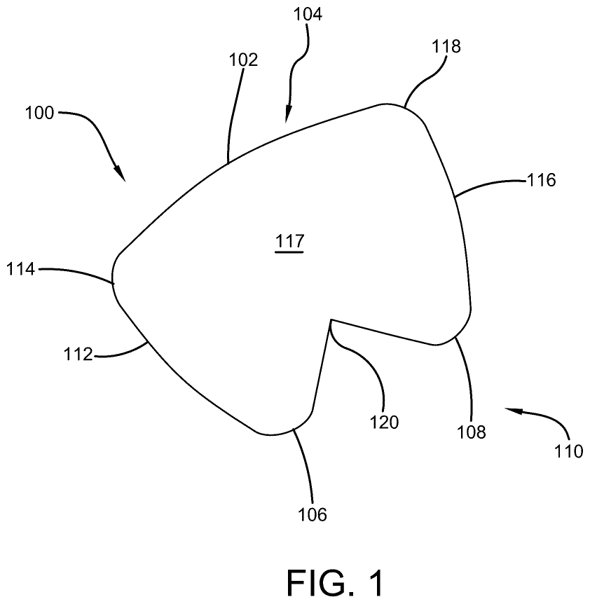

Referring initially to the drawings, FIG. 1 illustrates a perspective view of the double guitar pick of the present invention in accordance with the disclosed structure. The double guitar pick 100 of the present invention is designed to enhance the sound produced by a guitar. The double guitar pick 100 functions like a traditional guitar pick but improves amplification of sound emitted from the guitar strings. Amplification of sound in the present embodiment encompasses producing a brighter tone in the present disclosure. More specifically, the double guitar pick 100 includes a broad arcuate side 102 at the top end 104 and a pair of style tips 106, 108 at the bottom end 110. A first side edge 112 extends between the first end 114 of the broad arcuate side 102 and the first style tip 106. A second side edge 116 extends between the second end 118 of the broad arcuate side 102 and the second style tip 108.

The style tips 106, 108 align horizontally (i.e., colinear) and therefore, increases and preferably doubles the contact with the strings of a guitar in comparison to a conventional guitar pick and therefore increases vibrations. The inverted V-shape 120 between the style tips 106, 108 functions as a resonance chamber and helps in amplifying sound and providing a sharper attack. In the preferred embodiment, the broad arcuate side 102, the side edges 112, 116, and the style tips 106, 108 provide an interconnected teardrop shape to the double guitar pick 100. The double guitar pick 100 can be made of wood, plastic, bone, or metal and can be manufactured in a variety of colors to suit personal preferences or to match specific guitars or accessories.

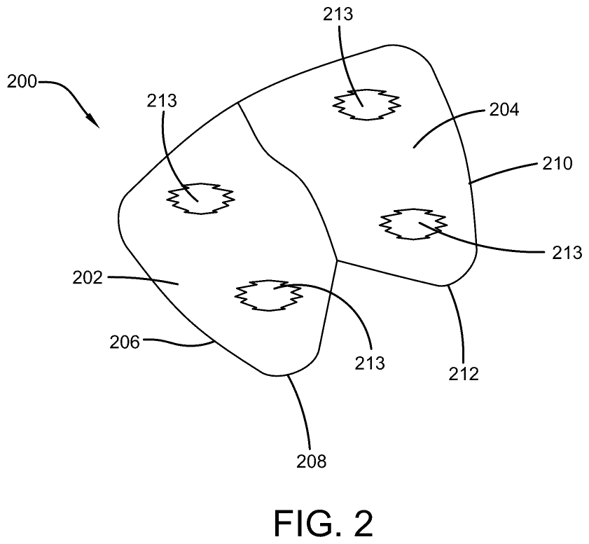

FIG. 2 illustrates a perspective view showing another embodiment of the double guitar pick 200 of the present invention in accordance with the disclosed structure. In the present embodiment, the first pick portion 202 is manufactured from a first material which can be wood, bone, or plastic and the second pick portion 204 is manufactured from a second material which is different from the first material and can be metal or any composite material. The first pick portion 202 has a side edge 206 and a first style tip 208 and the second pick portion 204 has a corresponding side edge 210 and a corresponding style tip 212.

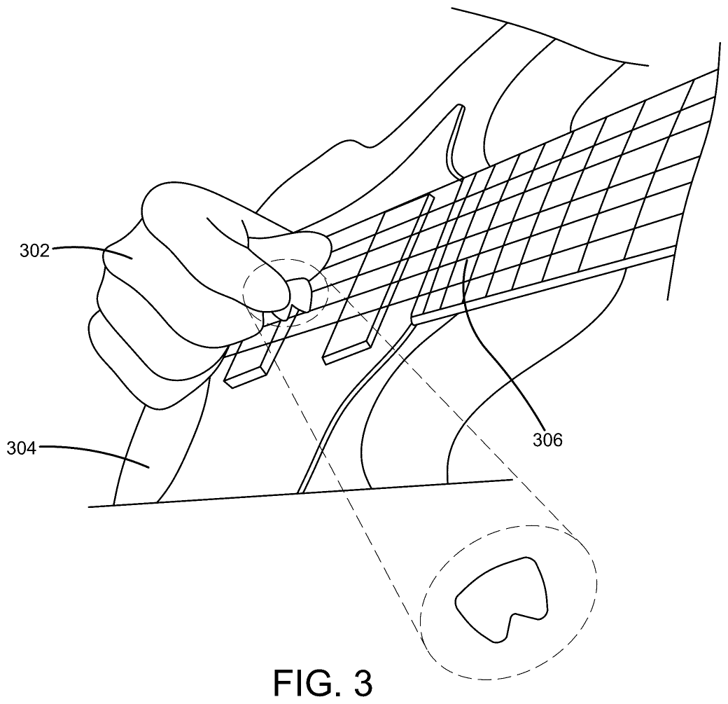

FIG. 3 illustrates a perspective view showing use of the double guitar pick of the present invention for playing a guitar in accordance with the disclosed structure. As illustrated, a user 302 can grip the acoustic enhancing double guitar pick 100 easily for playing a guitar 304. In use, the guitar pick 100 is positioned such that the style tips 106, 108 simultaneously touch at least one string 306 of the guitar 304 for vibrating the string of the guitar pick 100. The double guitar pick 100 is used without the need for new techniques and therefore is accessible to all guitarists. The double guitar pick 100 can enhance different playing styles, from strumming chords to picking individual notes.

In some embodiments, a plurality of tiny piezo materials 213 are embedded in the acoustic enhancing double guitar pick 100, 200 to enhance sound from the guitar. Piezoelectric materials are a special type of dielectric material that can accumulate electrical charge under an applied mechanical stress, resulting in the presence of opposite charges on the surfaces of each end of the material and producing a weak voltage. In particular, the first pick portion 202 and/or the second pick portion 204 can have piezoelectric materials 213 embedded therein. Further, in some embodiments, the double guitar pick 100, 200 can have variable thickness with the broad arcuate top end 102 thicker than the thinner style tips 106, 108. The guitar pick can have a textured outer surface 117 or rubberized sections thereon for better grip and control.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “acoustic enhancing double guitar pick”, “double guitar pick”, “guitar pick”, and “double guitar pick device” are interchangeable and refer to the guitar sound amplifying double guitar pick device 100, 200 of the present invention.

Notwithstanding the foregoing, the guitar sound amplifying double guitar pick device 100, 200 of the present invention can be of any suitable size and configuration as is known in the art without affecting the overall concept of the invention, provided that it accomplishes the above-stated objectives. One of ordinary skill in the art will appreciate that the guitar sound amplifying double guitar pick device 100, 200 as shown in the FIGS. are for illustrative purposes only, and that many other sizes and shapes of the guitar sound amplifying double guitar pick device 100, 200 are well within the scope of the present disclosure. Although the dimensions of the guitar sound amplifying double guitar pick device 100, 200 are important design parameters for user convenience, the guitar sound amplifying double guitar pick device 100, 200 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A guitar pick for enhancing guitar sound, the guitar pick comprising:
a double guitar pick having an arcuate side at a top end, a first style tip and a second style tip at a bottom end;
a first side edge extends between a first end of said arcuate side and said first style tip;
a second side edge extends between a second end of said arcuate side and said second style tip; and
further wherein said first style tip and said second style tip are colinear.

2. The guitar pick for enhancing guitar sound of claim 1, wherein said arcuate side, said first style tip, and said second style tip are coplanar.

3. The guitar pick for enhancing guitar sound of claim 1, wherein said bottom end having an inverted V-shaped edge extending between said first style tip and said second style tip.

4. The guitar pick for enhancing guitar sound of claim 1, wherein said double guitar pick having a material selected from the group consisting of a wood, a plastic, a bone, and a metal.

5. The guitar pick for enhancing guitar sound of claim 1, wherein said top end having a first thickness and said bottom end having a second thickness, further wherein said first thickness is greater than said second thickness.

6. The guitar pick for enhancing guitar sound of claim 1, wherein said double guitar pick having a textured outer surface.

7. The guitar pick for enhancing guitar sound of claim 4, wherein said material further including piezoelectric materials embedded therein.

8. A guitar pick for enhancing guitar sound, the guitar pick comprising:
a double guitar pick having a top edge, a first side portion including a first style tip at a bottom edge, and a second side portion including a second style tip at said bottom edge;
a first side edge extends between a first end of said top edge and said first style tip;
a second side edge extends between a second end of said top edge and said second style tip;
wherein said first style tip and said second style tip are colinear;
wherein said first side portion having a first material and said second side portion having a second material; and
further wherein said first material is different from said second material.

9. The guitar pick for enhancing guitar sound of claim 8, wherein said top edge, said first style tip, and said second style tip are coplanar.

10. The guitar pick for enhancing guitar sound of claim 8, wherein said bottom edge having an inverted V-shaped edge extending between said first style tip and said second style tip.

11. The guitar pick for enhancing guitar sound of claim 8, wherein said first material selected from the group consisting of a wood, a plastic, and a bone.

12. The guitar pick for enhancing guitar sound of claim 11, wherein said second material selected from the group consisting of a metal and a composite.

13. The guitar pick for enhancing guitar sound of claim 8, wherein said first side portion having a first area and said second side portion having a second area, further wherein said first area is equal to said second area.

14. The guitar pick for enhancing guitar sound of claim 8, wherein said top edge having a first thickness and said bottom edge having a second thickness, further wherein said first thickness is greater than said second thickness.

15. The guitar pick for enhancing guitar sound of claim 14, wherein said double guitar pick having a textured outer surface.

16. The guitar pick for enhancing guitar sound of claim 12, wherein said material further including piezoelectric materials embedded therein.

17. A guitar pick for enhancing guitar sound, the guitar pick comprising:
a double guitar pick having an arcuate side at a top end, a first style tip and a second style tip at a bottom end;
a first side edge extends between a first end of said arcuate side and said first style tip;
a second side edge extends between a second end of said arcuate side and said second style tip;
wherein said first style tip and said second style tip are colinear;
wherein said arcuate side, said first style tip, and said second style tip are coplanar;
wherein said arcuate side having a first thickness;
wherein said first style tip and said second style tip having a second thickness; and
further wherein said first thickness is greater than said second thickness.

18. The guitar pick for enhancing guitar sound of claim 17, wherein said double guitar pick having a first side portion and a second side portion, and further wherein said first side portion having a first area and said second side portion having a second area.

19. The guitar pick for enhancing guitar sound of claim 18, wherein said first side portion having a first material and said second side portion having a second material, and further wherein said first material is different from said second material.

20. The guitar pick for enhancing guitar sound of claim 19, wherein said first material selected from the group consisting of a wood, a plastic, and a bone, and further wherein said second material selected from the group consisting of a metal and a composite.
